(19) United States
(12) Patent Application Publication
(10) Pub. No.: US 2017/0192511 A1
(43) Pub. Date: Jul. 6, 2017

(54) Touchscreen Device and Method Thereof

(71) Applicant: Telefonaktiebolaget LM Ericsson (publ), Stockholm (SE)

(72) Inventors: Matthew John Lawrenson, Bussigny (CH); Till Burkert, Huddinge (SE); Julian Charles Nolan, Pully (CH)

(21) Appl. No.: 14/890,554

(22) PCT Filed: Sep. 29, 2015
(86) PCT No.: PCT/EP2015/072435

§ 371 Date: Nov. 11, 2015

(51) Int. Cl. G06F 3/01; G06F 3/042; G06F 3/041; G06F 3/0488; H04N 5/232

(52) U.S. Cl. CPC G06F 3/017; G06F 3/0488; H04N 5/232; G06F 3/0416; G06F 3/0425; H04N 5/23232

(57) ABSTRACT

According to the teachings herein, a method and apparatus are provided for facilitating touch entries to a touchscreen of an electronic device. In particular, the teachings herein facilitate one-handed touch entry, such as where a user operates the touchscreen of the device using a digit of the same hand used to hold the device. Advantageously, an electronic device (10) detects when a user is reaching to make a touch input to the touchscreen (14) and it correspondingly adapts the visual content currently being displayed—i.e., the current screen (16)—responsive to detecting the reach. Example adaptations include any one or more of shifting, warping and resealing the screen, to bring an estimated touch target within a defined reach extent (130) configured in the electronic device.

### TECHNICAL FIELD

The present invention relates to electronic devices having touchscreens, and particularly relates to adapting the screen layout on such a device responsive to detecting a reach event by a user of the device. The present invention further relates to a corresponding method and a corresponding computer program.

### BACKGROUND

Touchscreens have quickly become the standard interface mechanism for a host of electronic devices, including smartphones, tablets and other so-called portable computing or mobile devices. A number of use scenarios involved one-handed operation, such as when a user takes a “selfie” with a smartphone or engages in a video chat or casually browses the web. While increasingly large screens meet with enthusiastic consumer approval, these larger screens pose ergonomic and practical problems for many users, at least with respect to certain modes of operation, such as one-handed operation. For at least some users, one-handed operation becomes impossible once the screen size exceeds certain dimensions.

### SUMMARY

According to the teachings herein, a method and apparatus are provided for facilitating touch entries to a touchscreen of an electronic device. In particular, the teachings herein facilitate one-handed touch entry, such as where a user operates the touchscreen of the device using a digit of the same hand used to hold the device. Advantageously, an electronic device detects when a user is reaching to make a touch input to the touchscreen and it correspondingly adapts the visual content currently being displayed—i.e., the current screen—responsive to detecting the reach. Example adaptations include any one or more of shifting, warping and resealing the screen, to bring an estimated touch target within a defined reach extent configured in the electronic device.

In an example embodiment, a method is performed by an electronic device that includes a touchscreen. The method includes detecting that a user is reaching with a digit to make a touch input to the touchscreen, and temporarily adapting a screen currently being displayed on the touchscreen, to bring an estimated touch target within a defined reach extent that is configured in the electronic device.

In another embodiment, an electronic device includes a touchscreen and processing circuitry. The processing circuitry is configured to detect that a user is reaching with a digit to make a touch input to the touchscreen, and temporarily adapt a screen currently being displayed on the touchscreen, to bring an estimated touch target within a defined reach extent that is configured in the electronic device.

In at least one such embodiment, the electronic device includes a reach detection module for detecting that a user is reaching with a digit to make a touch input to the touchscreen, and further includes a screen adaptation module for temporarily adapting a screen currently being displayed on the touchscreen. As before, the adaption is performed to bring an estimated touch target within a defined reach extent that is configured in the electronic device.

In another embodiment, a non-transitory computer-readable medium stores a computer program comprising program instructions that, when executed by processing circuitry of an electronic device having a touchscreen, configures the electronic device to: detect that a user is reaching with a digit to make a touch input to the touchscreen, and temporarily adapt a screen currently being displayed on the touchscreen. The adaptation brings an estimated touch target within a defined reach extent that is configured in the electronic device.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a block diagram of one embodiment of a user device equipped with a touchscreen.

FIG. 2 is a logic flow diagram of one embodiment of a method of processing at an electronic device equipped with a touchscreen.

FIG. 3 is a block diagram of one embodiment of an arrangement of processing modules, corresponding to physical or functional circuitry of an electronic device equipped with a touchscreen.

FIG. 4 is a logic flow diagram of another embodiment of a method of processing at an electronic device equipped with a touchscreen.

FIG. 5 is a diagram of a user device equipped with a touchscreen and illustrated in a handheld orientation for touchscreen operation by a user.

FIG. 6 is a diagram depicting an example corneal-reflected image, such as used in at least some embodiments herein.

FIGS. 7 and 8 are block diagrams of screen shifting and screen scaling according to example embodiments.

### DETAILED DESCRIPTION

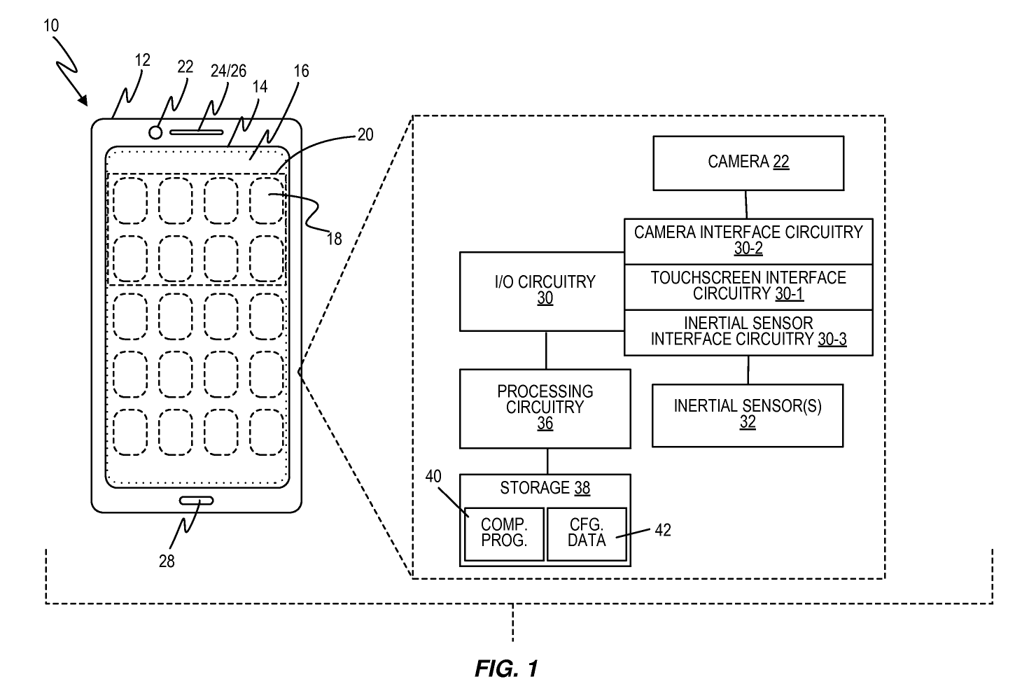

FIG. 1 illustrates an electronic device 10 having a housing or enclosure 12 and a touchscreen 14 configured for displaying visual content to a user of the device 10, and for receiving touch inputs from the user. The visual content displayed on the touchscreen 14 at any given time is referred to herein as a “screen” 16. Therefore, the word “screen” as used herein does not denote the physical touchscreen 14 but rather the image that is electronically created on the surface of the touchscreen 14.

The teachings herein are broadly referred to as “reach adaptation” teachings and they involve temporarily adapting the screen 16 responsive to detecting that a user of the device 10 is reaching with a digit, with respect to the touchscreen 14. Adapting the screen 16 means temporarily displaying a modified version of the screen 16, to bring an estimated touch target within a defined reach extent that is configured in the device 10.

To better understand this advantageous processing, consider that there may be any number of default screens 16 displayable on the touchscreen 14, e.g., device setting screens, application icon screens, etc., and screens 16 may be dynamically rendered, such as for web pages, streaming media and anything else having variable content. Any given screen 16 may comprise a mix of static and changing content, such as seen with web browsing applications that typically display navigation control icons in a perimeter around dynamically rendered content.

Distinct visual elements included within any given screen 16 are referred to herein as screen elements 18. Often, a screen element 18 serves as a control element, such as an icon that can be touched to launch a corresponding application or such as a hyperlink to a web page or other electronic content. When a screen element 18 is a control element, it represents a potential touch target, which means that a user can be expected to direct a touch input to the touchscreen 14 at the physical location at which the screen element 18 is being displayed.

It will also be appreciated that the screen 16 may be regarded as having screen regions 20, which are nothing more than given areas of the screen 16 as it is currently being displayed, such as top regions, corner regions, bottom regions, etc. When the screen 16 substantially occupies the entire viewable surface of the touchscreen 14, there is a substantially direct correspondence between screen regions 20 and corresponding spatial regions of the touchscreen 14. However, a screen region 20 may move from one physical area of the touchscreen 14 to another when the screen 16 is adapted according to the reach adaptation teachings taught herein. For example, as taught herein, the device 10 detects that a user is extending a digit towards an estimated touch target and adapts the screen 18 to bring that touch target within a defined reach extent that is configured for the device 10.

Before considering these teachings in more detail, it will be helpful to highlight other components or elements of the example device 10 depicted in FIG. 1. Among these further components are a camera 22, a microphone 24 and/or speaker(s) 26. Here, the camera 22 is a “front-facing” camera assembly, having a physical orientation and field-of-view like that commonly seen on smartphones for taking “selfies” and for imaging the user during video calling applications. In other words, in a designed-for or normal handheld orientation of the device 10, the camera 22 is positioned within the housing 12 of the device 10 such that its field of view encompasses all or at least a portion of the face of the user. This optical configuration complements use of the camera 22 for taking one-handed selfies, for example.

Internally, the device 10 includes Input/Output or I/O circuitry 30, which in the example includes touchscreen interface circuitry 30-1 for interfacing with the touchscreen 14, camera interface circuitry 30-2 for interfacing with the camera 22, and inertial sensor interface circuitry 30-3 for interfacing with one or more inertial sensors 32 included within the device 10. A multi-axis accelerometer fabricated using micro-electromechanical system, MEMS, technology is one example of an inertial sensor 32.

The device 10 also includes processing circuitry 36 that interfaces to the touchscreen 14, the camera 22, and the inertial sensor(s) 32 via the I/O circuitry 30. The processing circuitry 36 is configured to perform reach adaptation for the device 10, according to any one or more of the embodiments taught herein. Example circuitry includes one or more microprocessors, microcontrollers, Digital Signal Processors, DSPs, Field Programmable Gate Arrays, FPGAs, Application Specific Integrated Circuits, ASICs, System-on-a-Chip, SOC, modules. More generally, the processing circuitry 36 comprises fixed circuitry, programmed circuitry, or a mix of fixed and programmed circuitry.

In at least one embodiment, the processing circuitry 36 includes or is associated with storage 38, which stores a computer program 40 and configuration data 42. Among other things, the configuration data 42 may include calibration data defining the aforementioned reach extent, and the computer program 40 in one or more embodiments comprises computer program instructions that, when executed by one or more processing circuits within the device 10, result in the processing circuitry 36 being configured according to the reach adaptation processing taught herein.

In this regard, the storage 38 comprises one or more types of non-transient computer readable media, such as a mix of volatile memory circuits for working data and program execution, and non-volatile circuits for longer-term storage of the computer program 40 and the configuration data 42. Here, non-transient storage does not necessarily mean permanent or unchanging storage but does connote storage of at least some persistence, i.e., the storing of data for subsequent retrieval.

With the above points in mind, consider an exemplary configuration of the contemplated device 10, which includes a touchscreen 14 and processing circuitry 36. The processing circuitry 36 is configured to detect that a user is reaching with a digit to make a touch input to the touchscreen 14 and temporarily adapt a screen 16 currently being displayed on the touchscreen 14, to bring an estimated touch target within a defined reach extent that is configured in the electronic device 10.

Reach detection may be based on detecting from internal inertial sensor data that a movement or orientation of the device 10 that is characteristic of the user holding the device 10 in one hand while extending a digit of that hand to make a touch input to the touchscreen 14 at a location that is difficult for the user to reach. For example, it becomes increasingly more difficult to operate the touchscreens of smartphones and other mobile communication and computing devices as those screens become larger. Users often twist, tilt or otherwise shift such devices in the hand being used to hold the device, in order to better extend a digit to a hard-to-reach location on the touchscreen. In the context of the device 10, such shifting, twisting or the like can be detected from the inertial sensor data and used as a mechanism to infer that the user is reaching to make a touch input.

Regardless of how reach detection is implemented, the processing circuitry 36 in one or more embodiments is configured to temporarily adapt the screen 16—i.e., the currently displayed visual content—by displaying a modified version of the screen 16 until at least one of: detecting a touch input to the touchscreen 14, detecting expiration of an adaptation time-out period, or detecting that the digit of the user is no longer in a reaching orientation. In a particular example, the device 10 detects that the user is reaching to make a touch input, and temporarily modifies the screen 16 to facilitate that touch input, such that it reverts back to the previous version of the screen if no touch input is received within a defined time window and/or it detects that the user is no longer reaching, or receives a touch input and displays whatever visual content is triggered by the touch input.

Referring specifically to FIG. 1, consider a case where the touch extent defines the comfortable reach extent of the user with respect to a lower left corner of the touchscreen 14, such as might apply for a user that prefers to hold the device 10 in her left hand and operate the touchscreen 14 using her left thumb. Assume further that the user is reaching towards the screen region 20 in FIG. 1, which in that illustration is a top region of the screen 16. In such an example case, the processing circuitry 36 adapts the screen 16 by shifting the screen region 20 down on the touchscreen 14, so that it is moved within reach of the user's thumb. Additionally, or alternatively, the processing circuitry 36 can rescale all or part of the screen 16, so that the screen region 20 is moved within reach of the user's thumb. Similarly, the processing circuitry 36 can warp the screen 16—e.g., a selective magnification, bending or shifting—to bring the screen region 20 within reach of the user's thumb. These same processes may be performed for individual screen elements 18 rather than entire screen regions 20, such as where there is only one or a select few screen elements 18 in the direction that the user is reaching. Bringing individual screen elements 18 into the user's reach is particularly advantageous for screens 16 that have only one or a limited number of screen elements 18 that are (1) outside of the defined reach extent, (2) operative as control elements, and (3) in the direction of reach.

In at least one embodiment, the processing circuitry 36 is configured to temporarily adapt the screen 16 by determining a layout modification for the screen 16 to bring the touch target within the defined reach extent, and modifying a layout of the screen 16 according to the layout modification. For example, the processing circuitry 36 may select a default layout modification that is generally applied when the user is reaching towards the top of the touchscreen 14, and another default layout modification used for side reaches, and so on. Additionally, or alternatively, different screens 16 and/or different screen types may be associated with different adaptations.

In one example, “native” or “home” screens 16 are adapted according to default configurations—e.g., screen shifting is always used—while application-specific screens 16 are adapted according to any prevailing application settings. If no such settings exist—e.g., the application is not “reach adaptation” aware, the default settings may be applied. In other instances, some screens 16 are more dense or busier than others, and the number, placement and spacing of “touchable” screen elements 18 on the currently-displayed screen 16 determines whether the processing circuitry 36 shifts the screen 16, rescales the screen 16, or warps the screen 16, or performs some combination of two or more of those techniques.

In one or more embodiments, the processing circuitry 36 is configured to identify the touch target as being a screen element 18 or screen region 20 that is outside of the defined reach extent and in a determined reach direction. In this sense, the processing circuitry 36 has some awareness of what is being displayed and may recognize that one or more “touchable” screen elements 18 are being displayed on the touchscreen 14 in an area or areas outside of the defined reach extent. This information, in conjunction with determining at least a general direction of reaching, is sufficient to guess accurately at the screen element(s) 18 the user is attempting to reach.

As for the defined reach extent, the processing circuitry 36 in one or more embodiments is configured to perform a calibration routine. According to the calibration routine, the processing circuitry 36 prompts the user—e.g., visual prompts output from the touchscreen 14—to make one or more touch inputs to the touchscreen 14. The processing circuitry 36 defines the defined reach extent based on the one or more touch inputs received during the calibration routine. In a specific example, the prompts instruct the user to hold the device 10 in the hand preferred for use in one-handed operation of the device 10 and to use a preferred digit to trace or otherwise define by a series of touches on the surface of the touchscreen 14 the comfortable physical reach extent of that digit. In at least one such embodiment, the device 10 displays touch points or visually fills in the areas of the touchscreen 14 that are encompassed within the reach extent.

Further, in at least some embodiments the device 10 includes a fingerprint sensor or other biometric recognition feature, such that it can identify the user, at least in terms of associating different biometric signatures with different reach extents. That is, when a given user is logged in, the reach extent learned by the device 10 may be associated with that account, such that one or more other users having different logins may each calibrate their reach extents. In general, to the extent that the device 10 understands different users or different user accounts, with or without biometric sensing, the device 10 may store different defined reach extents and the defined reach extent used by the processing circuitry 36 at any given time may be specific to the user using the device 10 at that time. In other embodiments, the device 10 simply offers a calibration routine and maintains only one defined reach extent to be used with respect to anyone using the device 10.

In another aspect of reach adaptation, the processing circuitry 36 is configured in at least some embodiments to detect that the user is reaching with the digit to make the touch input to the touchscreen 14 by detecting that the digit is hovering over the touchscreen 14 in conjunction with detecting that the digit is in a reaching orientation with respect to the touchscreen 14. Detecting reaching and hovering together is advantageous because the coincident conditions of extending the digit and holding the digit close to the surface of the touchscreen 14 are characteristic of the user straining to reach a touch target.

Certain touchscreen technologies, such as some capacitive-based touchscreen technologies, lend themselves to hover detection. That is, a touchscreen 14 embodying certain types of capacitive touch sensing will inherently provide signal outputs from which the processing circuitry 36 can determine that the tip or other part of the digit of the user is being held just above the surface of the touchscreen 14. Further, as will be seen in other embodiments, image processing may be used not only to detect that a digit of the user is in a reaching orientation with respect to the touchscreen, but also to detect that the digit is hovering. For example, if a sequence of two or more images captured over a defined time period indicate that the digit of the user is extended in a reaching orientation and if no touch inputs have been detected during that same period, the processing circuitry 36 in at least some embodiments is configured to deduce that the user is reaching for a touch target.

In at least one embodiment where the electronic device 10 includes a camera 22, the processing circuitry 36 is configured to detect that the user is reaching with the digit to make the touch input to the touchscreen 14 by obtaining one or more images from the camera 22, and determining from image data obtained from the one or more images that the digit of the user is in a reaching orientation with respect to the touchscreen 14. In at least one such embodiment, the processing circuitry 36 is configured to determine a reach direction from the image data and determine the touch target based at least on the reach direction.

Here, it will be appreciated that the touchscreen 14 does not lie within a field of view of the camera 22. Rather, the camera 22 is oriented to face the user in at least one handheld orientation of the electronic device 10, and the processing circuitry 36 is configured to determine that the user is reaching with the digit to make the touch input to the touchscreen 14 by: extracting one or more cornea-reflected or eyewear-reflected images from the one or more images; processing the one or more reflected images, as said image data, to obtain orientation information for the digit with respect to the touchscreen 14; and detecting that the digit is in a reaching orientation with respect to the touchscreen 14 and detecting a corresponding reach direction. Such detections are made from the orientation information obtained for the digit.

It is also contemplated herein to activate the camera 22 for such imaging on a controlled basis, e.g., the camera 22 may normally be powered down or disabled for privacy reasons and/or to save power. In at least one embodiment, the processing circuitry 36 is configured to control the camera 22 to be active in response to at least one of: determining that the screen 16 is a certain screen or a certain type of screen for which reach detection is to be active; determining that the screen 16 includes one or more screen elements 18 that are operative as touch inputs and are outside of the defined reach extent; and detecting a movement or orientation of the device 10 that is characteristic of reach events. Such movement or orientation may be determined from inertial sensor data available within the device 10.

In at least one embodiment, the one or more images used for reach detection comprise at least two images. Here, the processing circuitry 36 is configured to jointly process two or more of the at least two images to obtain one or more enhanced-resolution images and to use the enhanced-resolution images for determining whether the digit of the user is in a reaching orientation with respect to the touchscreen 14. Such embodiments are especially useful when the native image quality from the camera 22 is not sufficient for reliable extraction of reflected images, for reach detection processing.

Broadly, in at least one embodiment, the processing circuitry 36 is configured to detect that the user is reaching with a digit to make a touch input to the touchscreen 14 by detecting a movement or orientation of the electronic device 10 that is characteristic of the user extending the digit in a reaching motion with respect to the touchscreen 14 while holding the electronic device 10 in the hand associated with the digit. In one embodiment, the detection is based on sensing the characteristic movement or orientation from the inertial sensor signals. In another embodiment, the detection is based on detecting a characteristic shift or movement of one or more features in the image data captured by the camera 22, such as detecting an apparent shift or movement of the user's face within the camera's field of view. Image processing in this second example also may include tracking or otherwise detecting from the image data that the user is looking at the electronic device 10. Still further, in at least one embodiment, the electronic device 10 detects that the user is reaching with the digit to make a touchscreen input based on detecting the characteristic movement or orientation—e.g., via inertial sensing—in conjunction with detecting that the digit is in a reaching orientation, based on processing image data from the camera 22.

Thus, in at least one embodiment, the processing circuitry 36 is configured to detect that the user is reaching with a digit to make a touch input to the touchscreen 14 by processing one or more images obtained from a camera 22 that is integrated within the electronic device 10 and has a field of view that encompasses at least a portion of the face of the user. The camera 22 is therefore used to obtain one or more cornea-reflected images, and reach detection includes processing the one or more cornea-reflected images to determine whether the digit, as visible in the one or more cornea-reflected images, is in a reaching orientation with respect to the touchscreen 14.

In practice, the device 10 may be any type of equipment or apparatus. For example, the device 10 may be one of a mobile terminal, a mobile phone, a smartphone, or a User Equipment, UE, or a personal or mobile computing device, such as a “phablet”. The word “phablet” denotes a touchscreen device that is larger than the typical handheld smartphone but smaller than the typical tablet computer. Example phablet screen sizes range from 5.5 in. to 6.99 in. (13.97 cm to 17.75 cm). Phablets thus represent a prime but non-limiting example of a relatively large-screen device that is intended for handheld touch operation.

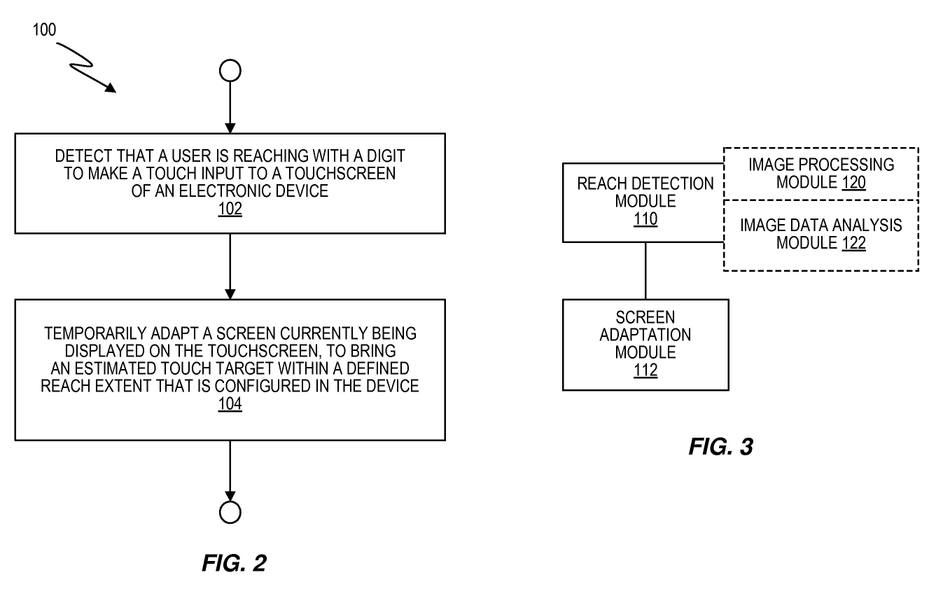

FIG. 2 illustrates a method 100 performed by a device 10. The device 10 may be any of the example device types mentioned above, but it is not limited to those types. However, the device 10 does include a touchscreen 14. Correspondingly, the method 100 includes detecting (Block 102) that a user is reaching with a digit to make a touch input to the touchscreen 14, temporarily adapting the screen currently being displayed on the touchscreen, to bring an estimated touch target within a defined reach extent that is configured in the device 10.

The estimated touch target may be the screen elements 18 or the screen region 20 lying outside of the defined reach extent and in a general direction of reaching. Alternatively, the estimated touch target may be one or more particularly selected screen elements 18 or a specific portion of a screen region 20, based on knowledge of what touch targets are currently being displayed along the direction of reach and outside the defined reach extent.

FIG. 3 illustrates another embodiment of the device 10 and may be understood as illustrating physical or functional circuitry or modules within the device 10, such as may be realized within the processing circuitry 36 according to the execution of computer program instructions from the computer program 40. The depicted modules include a reach detection module 110 for detecting that a user is reaching with a digit to make a touch input to the touchscreen 14, and a screen adaptation module 112 for temporarily adapting a screen 16 currently being displayed on the touchscreen 14, to bring an estimated touch target within a defined reach extent that is configured in the electronic device 10.

The reach detection module 110 may include further modules or sub-modules, such as an image processing module 120 and an image data analysis module 122. For example, the image processing module 120 processes images of the user's face as obtained from the camera 22, to extract image data corresponding to corneal-reflected images from one or both eyes of the user, and the image data analysis module 122 processes that image data to identify the user's hand or at least one or more digits on the hand and to determine whether a digit of the user is in a reaching orientation—extended—with respect to the touchscreen 14.

Such processing may be realized by storing a computer program 40 in the storage 38, for execution by the processing circuitry 36. Such a program includes program instructions that, when executed by the processing circuitry 36, configures the electronic device 10 to: detect that a user is reaching with a digit to make a touch input to the touchscreen 14, and temporarily adapt a screen 16 currently being displayed on the touchscreen, to bring an estimated touch target within a defined reach extent that is configured in the electronic device 10.

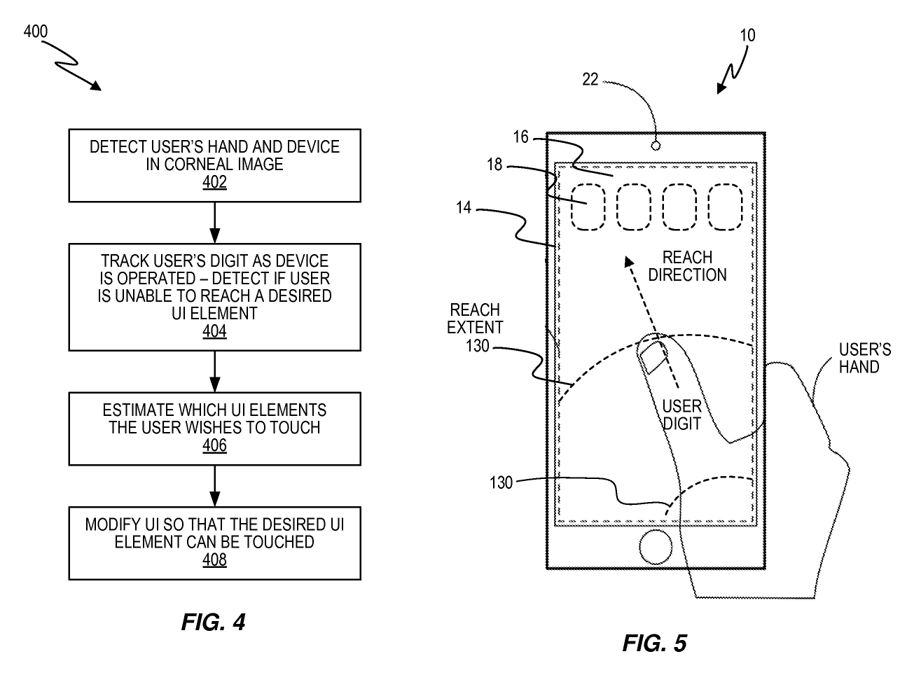

FIG. 4 depicts a method 400 of processing at a device 10 having a touchscreen 14. The method 400 may be understood as a more detailed version of the method 100, and it includes detecting (Block 402) a user's hand and the device 10 within a corneal-reflected image extracted from an image of one or both eyes of the user, as obtained via the camera 22. The method 400 further includes tracking (Block 404) the digit of the user as the device 10 is being operated by the user, to determine whether it appears that the user is unable to reach a desired screen element 18—which here comprises a User Interface or UI element providing touch-input control.

The method 400 further includes determining (Block 406) which UI elements the user wishes to reach—i.e., estimating the touch target. The estimation may be gross, i.e., all UI elements in the general direction of reach and outside of the defined reach extent, or it may be more particularized. For example, specific UI elements may be inferred as being the touch target, based on determining which UI elements are in a specific direction of reach and outside the defined reach extent. The method 400 further includes modifying the UI—i.e., adapting the currently displayed screen 16, which can be understood as embodying a UI—so that the desired UI elements can be touched by the user (Block 408).

FIG. 5 provides a further helpful illustration in the context of one-handed operation of a device 10 by a user holding the device 10 in her right hand and using her right thumb to operate the device 10 in a one-handed fashion. One sees that the defined reach extent, numbered here as “130”, is a roughly circular arc covering a portion of the touchscreen surface area but leaving unreachable touchscreen areas above and below. Thus, while the extension of a digit may be a telltale sign of reaching, it is also appreciated herein that bending the digit, e.g., bending the right thumb to reach a screen element 18 in the lower right corner of the touchscreen 14, may also constitute reaching.

In FIG. 5, one row of screen elements 18 is shown merely as an example. There may be multiple rows of screen elements 18 also displayed simultaneously in the given screen 16. The illustration is merely intended to show that the top row of screen elements 18 is generally in the example reach direction. Therefore, screen shifting, warping and/or resealing may be performed to bring the entire top row of screen elements 18 within the defined reach extent 130. By that, it is meant that top row of screen elements 18 is displayed on a physical area of the touchscreen 14 lying within the defined reach extent 130.

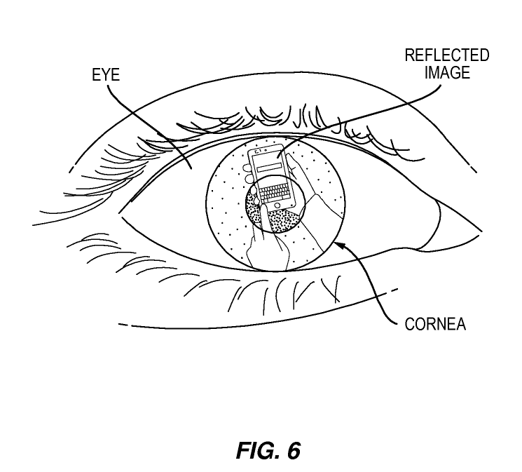

FIG. 6 provides an example of a cornea-reflected image, such as may be included within an image captured by the camera 22. That is, the user is looking at the touchscreen 14 during normal operation of the device 10, or at least while interacting with the touchscreen 14. The camera 22 is oriented to image the user during such operation, and, therefore, the images obtained from the camera are expected to contain the user's face or a portion thereof. Facial recognition processing can be performed to detect the eye region(s) in the user images, and extraction processing can be performed to extract the eye portions of the image that contain the corneal reflection. In turn, those reflected images are processed according to one or more embodiments taught herein, to detect reaching. For more details regarding corneal imaging, the reader is referred to “Corneal Imaging System: Environment from Eyes,” K. Nishino and S. K. Nayar, International Journal on Computer Vision, October 2006, and “The World in an Eye,” K. Nishino and S. K. Nayar, IEEE Conference on Computer Vision and Pattern Recognition (CVPR), Vol. I, pp. 444-451, June 2004. For further reference, see “Corneal Imaging Revisited: An Overview of Corneal Reflection Analysis and Applications,” Nitschke, C., et al., IPSJ Transactions on Computer Vision and Applications Vol. 5 1-18 (January 2013).

In consideration of the above teachings, it will be appreciated that it is contemplated herein to implement or otherwise configure a device 10 with a touchscreen 14 and a front-facing camera 22—where “front” denotes the intended purposes of imaging a user of the device 10. A corneal imaging subsystem—processing circuitry—is implemented within the device 10 and is used to obtain a reflected image from one or both eyes of the user. That reflected image contains an image of the device 10 and one or both hands of the user, as being used to operate the device 10.

In at least one such embodiment, the device 10 implements an algorithm to detect when the user is likely to be having difficulty in reaching a UI element currently being displayed on the touchscreen 14, and a further algorithm to determine a modification of the UI required to enable the user to reach the UI element as a touch target. The modification may be optimized, e.g., to bring the most likely touch target, or a few mostly likely touch targets, within reach. Additionally, or alternatively, the optimization tries to minimize the loss or distortion of other screen content. In these and other regards, corneal imaging is used to detecting reaching by the user with respect to the touchscreen 14, and the device 10 in response to such detection deduces an optimum change in the UI layout to allow the user to reach the desired UI element and the adapts the UI layout accordingly.

In at least one embodiment, the device 10 is configured to monitor the user's digits using corneal imaging, and recognize instances where a user wishes to touch an area of the touchscreen 14 that is not within a defined reach extent. Note that the defined reach extent may be learned for the user, or may be a default, preconfigured value that is used, e.g., when the reach extent has not been calibrated or in embodiments of the device 10 that do no provide for such calibration. More broadly, the defined reach extent may be defined or estimated on the fly, such as by detecting that a digit of the user appears to be extended with respect to the touchscreen 14. On the fly determination of the defined reach extent may be made more robust by detecting that the digit remains in the extended orientation for some period of time and/or “hovering” is detected in conjunction with seeing the extended orientation of the digit. The device 10 assesses the UI layout changed needed to bring one or more out-of-reach UI elements within reach and modifies the UI accordingly.

At least for purposes of discussion, the various algorithmic processing involved in reach adaptation as taught herein may be separated into a Corneal Image Identification, CII, algorithm, a Digit Reach, DR, algorithm, and a User Interface Adaptation, UIA, algorithm. The CII algorithm identifies the relevant image in the user's cornea and performs any image processing necessary to enable the image to be used by the DR Algorithm—i.e., it provides the DR algorithm with image data corresponding to the corneal image. In turn, the DR algorithm uses the corneal images as input and tracks the user's digit(s), to identify when the user is attempting to reach an onscreen UI element. Complementing the DR processing, the UIA algorithm modifies the UI—i.e., the currently displayed screen 16—to bring one or more UI elements into the defined reach extent 130.

In one embodiment, the length of the user's digit is determined and stored in a preference file. An example calibration routine or the like, the user places her hand on the touchscreen 14, with the operational digit fully extended. The operational digit is the digit the user intends to use for making touch inputs, e.g., the thumb of the hand in which the device 10 is most comfortable for the user to hold. An “outline image” may be displayed on the touchscreen 14 to guide hand placement. The regions of the touchscreen 14 that are contacted during the calibration routine are sensed and used to estimate digit length. Here, the touch points—contact points—detected during calibration may be fitted to a generic hand model stored in the device 10, to provide an estimate of the “Max Finger Length” and the point of the corresponding digit that touches the screen, referred to as the “DTP”.

Alternatively, the user may be prompted to hold the device 10 in an operational orientation in a single hand of the user, and the user is then prompted to swipe across the touchscreen 14 using the preferred operational digit, or to otherwise make a series of touch inputs to the touchscreen 14 that represent the comfortable reach extent of the user. In yet another alternative, the device 10 defines the reach extent of the user over time, based on touch patterns observed during normal operation of the device 10.

During actual usage, the CII algorithm obtains an image of the user's hand via the camera 22. In more detail, the camera 22 captures an image containing at least one of the user's corneas, which in turn contains a reflection of both the device 10 and the hand the user is using to operate the device 10. The CII algorithm isolates the portion of the image containing the device 10 and the hand and compensates the isolated image for cornea curvature, etc. Compensation may be based on specific dimensions of the user's cornea, e.g., gathered at a previous time, or may use a general model of corneal curvature. Compensation may be further aided based on the device 10 being configured with values representing its screen size, screen proportions—e.g., width versus height—and also based on dynamically known information, e.g., at any given time the device 10 “knows” what is being displayed. Optional further image compensation accounts for the angle at which the device 10 is being held, as ascertained using the inertial sensor data.

The result of this processing is an image of the user's hand operating the device 10, where the scaling of the image due to the curvature of the user's eye, and also optionally the device 10 being in a non-parallel plane, has been compensated for. This image is defined as the “Corneal Image”.

The above steps may be repeated over time and for a series of captured images, to thereby allow the device 10 to track the position of the user's digit over time, in relation to the touchscreen 14 of the device 10. The DR Algorithm here takes a succession of Corneal Images as an input and determines when the user is attempting to reach a UI element, e.g., the DR algorithm detects when the digit is in its maximum “stretched” position.

An example approach takes a Corneal Image as an input and uses the Corneal Image to track the current “apparent” length of the digit. The apparent length is compared to the stored Max Finger Length of the user. Where the lengths are comparable, but the where the tip of the digit is not positioned over a UI Element, the device 10 assumes that the user is reaching for an out-of-reach UI element.

Digit length may be determine in centimeters, such as by using the known length of one side of the device 10 in conjunction with the apparent length of that side as determined from the Corneal Image. In other words, the device 10 may include in its configuration data 42 dimensional information about the device's exterior features, and it can use such data to estimate the lengths of other objects—e.g., user digits—seen in the same Corneal Image. Similarly, two features with known separation, e.g. two corners of the device 10, or two UI Elements with known placement on the touchscreen 14 are identified in the Corneal Image, and the distance between them in cm is defined as “d”. The number of pixels in the Corneal Image that correspond to d is then calculated, and this is defined as “p”. The length of the user's digit in the Corneal Image is then calculated in pixels, this is defined as ‘P’. To find the length in cm D, the equation D=P*(d/p) may be used.

Optionally, the DR algorithm consider other factors to improve the accuracy of the assessment made above. For example, the DR algorithm considers any one or more of: whether the user deviates the angle at which the digit is being held; whether readings from the touchscreen 14 indicate the digit is being held slightly above the screen, which is an unnatural holding position if it is not the intention to make a touch input; and whether a sequence of Corneal Images shows the user is making small movements, indicating the user is “stretching”.

Determination by the DR algorithm that the user is attempting to reach a UI Element triggers the UTA algorithm to modifies the UI to allow the UI Element to be reached. In one example, a set of UI Elements is identified as touch target or “Potential UI Elements”. In an embodiment of such processing, the device 10 ascertains the direction the user's digit is pointing from the Corneal Image, and identifies which touchable UI Elements are beyond the reach of the digit and within a certain threshold angle of the user's digit, e.g., 20 degrees. The UI is changed such that the most distant Potential UI Elements can be touched.

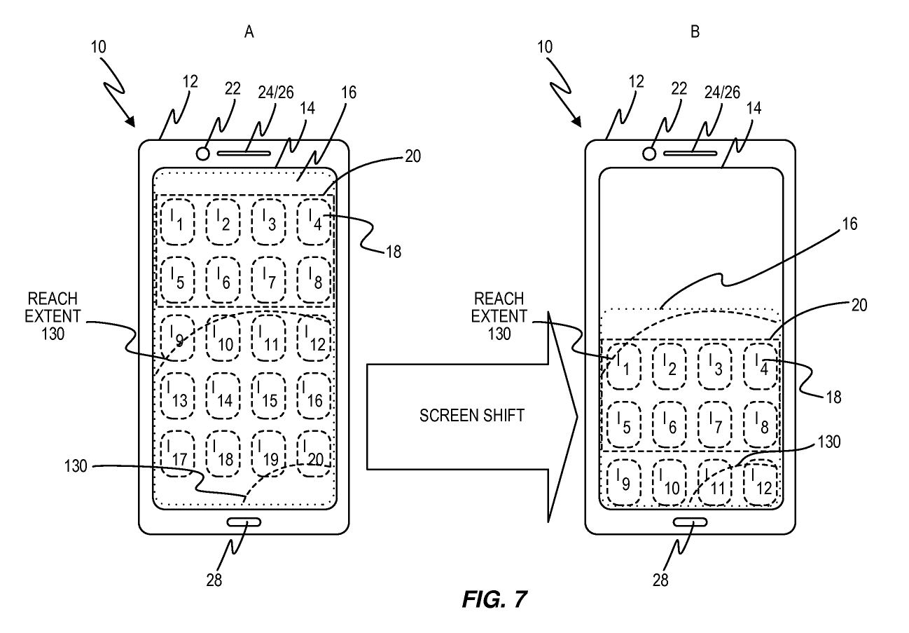

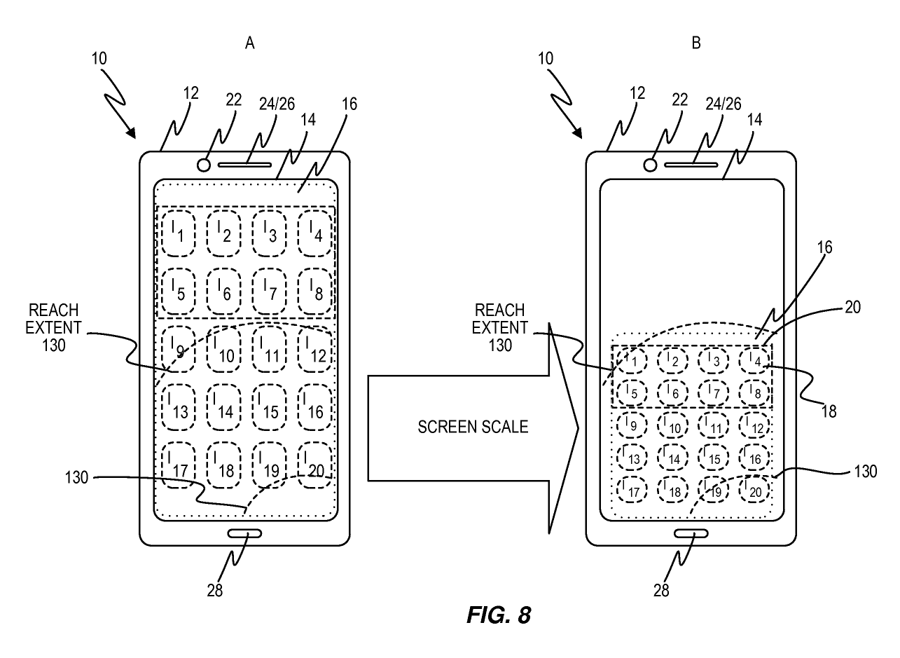

The change may comprise shifting the entire UI area such as shown in non-limiting example of FIG. 7, shrinking the entire UI area such as shown in the non-limiting example of FIG. 8, or performing some combination of shrinking and shifting. Note that shifting or scaling the screen 16 may shift or scale the display 16, including any background wallpaper or image, and may include displaying blank or black space in the physical regions of the touchscreen 14 that were used before the shifting or scaling. Alternatively, the shifting or scaling applies only to the screen elements 18 that are overlaid on the current background image.

In further related variations, the device 10 may warp the screen 16, such as by shifting the touch target so that it lies within the physical portion of the touchscreen 14 representing the reach extent 130 of the user, while simultaneously shrinking the remaining portion of the display 16. Consequently, it should be appreciated that the screen modifications may include shifting, resealing, magnifying, distorting, etc., or any combination of those techniques. Once the UI Element has been touched, the UI returns to a “full-screen” representation, although the full-screen representation may change as natural consequence of the touch input.

In another embodiment, when determining the reach extent of the user's digit with respect to the touchscreen 14, image processing is used to find the base and first knuckle of the digit—i.e., the metacarpophalangeal and interphalangeal joints. The identification of these points is made using the Corneal Image and image processing techniques. Using knowledge of the two extremities of the digits and the first knuckle, along with knowledge of the possible axis of movement allowed by human digits, the device 10 makes a more sophisticated determination of which portions of the touchscreen shall be considered as inside or outside of the defined reach extent.

Further, as noted, the maximum reach distance of a user can be determined from usage patterns rather than by geometric measurements of the finger. As the user operates the device 10, and touches the screen, a map is built up thereby identifying which areas they can touch without substantially shifting or reorienting the device 10, such as can be sensed from inertial sensor data. Although such mapping may be influenced by where or how the user changes how she holds the device 10 from time to time, such variations may be compensated for by using the location of a well-known gesture—the unlock swipe, for example—as a calibration factor. The map thus can be created relative to the position of the a reliable, repeatable gesture, and then implemented relative to the user's current holding position.

In yet another embodiment, the estimated touch target is not explicitly determined. Instead, the device 10 changes the UI such that a far corner of the UI is brought within the defined reach extent. In other words, for a given direction of reach, the device 10 may assume that anything within the corner of the screen 16 that the user is reaching towards is a potential touch target.

Broadly, then, the teachings herein enable a user to reach all touchable UI elements on a large touchscreen 14 without the need to touch a specific button to initiate a reachability modification of the UI. Instead, UI adaptations are automatically triggered based on the read detection taught herein.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-31. (canceled)

32. A method performed by an electronic device having a touchscreen, said method comprising:
detecting that a user is reaching with a digit to make a touch input to the touchscreen; and
temporarily adapting a screen currently being displayed on the touchscreen, to bring an estimated touch target within a defined reach extent that is configured in the electronic device.

33. The method of claim 32, wherein temporarily adapting the screen comprises displaying a modified version of the screen until at least one of: detecting a touch input to the touchscreen, detecting expiration of an adaptation time-out period, or detecting that the digit of the user is no longer in a reaching orientation.

34. The method of claim 32, wherein temporarily adapting the screen comprises determining a layout modification for the screen to bring the touch target within the defined reach extent, and modifying a layout of the screen according to the layout modification.

35. The method of claim 32, further comprising identifying the touch target as being a screen element or screen region that is outside of the defined reach extent and in a determined reach direction.

36. The method of claim 32, wherein temporarily adapting the screen comprises at least one of: shifting the screen, rescaling the screen, and warping the screen.

37. The method of claim 32, further comprising, in a calibration routine, prompting the user to make one or more touch inputs to the touchscreen and defining the defined reach extent based on the one or more touch inputs received during the calibration routine.

38. The method of claim 32, wherein detecting that the user is reaching with the digit to make the touch input to the touchscreen comprises detecting that the digit is hovering over the touchscreen in conjunction with detecting that the digit is in a reaching orientation with respect to the touchscreen.

39. The method of claim 32, wherein the electronic device includes a camera and wherein detecting that the user is reaching with the digit to make the touch input to the touchscreen comprises obtaining one or more images from the camera, and determining from image data obtained from the one or more images that the digit of the user is in a reaching orientation with respect to the touchscreen.

40. The method of claim 39, further comprising determining a reach direction from the image data, and determining the touch target based at least on the reach direction.

41. The method of claim 39, wherein the touchscreen does not lie within a field of view of the camera, wherein the camera is oriented to face the user in at least one handheld orientation of the electronic device, and wherein detecting that the user is reaching with the digit to make the touch input to the touchscreen comprises:
extracting one or more cornea-reflected or eyewear-reflected images from the one or more images;
processing the one or more reflected images, as said image data, to obtain orientation information for the digit with respect to the touchscreen; and
detecting that the digit is in a reaching orientation with respect to the touchscreen and detecting a corresponding reach direction, from the orientation information obtained for the digit.

42. The method of claim 39, further comprising controlling the camera to be active in response to at least one of:
determining that the screen is a certain screen or a certain type of screen, for which reach detection is to be active;
determining that the screen includes one or more screen elements that are operative as touch inputs and outside of the defined reach extent; and
detecting a movement or orientation of the electronic device that is characteristic of reach events, said movement or orientation being determined from inertial sensor data available within the electronic device.

43. The method of claim 39, wherein the one or more images comprise at least two images, and further comprising jointly processing two or more of the at least two images to obtain one or more enhanced-resolution images and using the enhanced-resolution images for determining whether the digit of the user is in a reaching orientation with respect to the touchscreen.

44. The method of claim 32, wherein detecting that the user is reaching with the digit to make the touch input to the touchscreen comprises detecting a movement or orientation of the electronic device that is characteristic of the user extending the digit in a reaching motion with respect to the touchscreen while holding the electronic device in the hand associated with the digit, in conjunction with detecting that the digit of the user is in a reaching orientation with respect to the touchscreen.

45. The method of claim 32, wherein detecting that the user is reaching with the digit to make the touch input to the touchscreen comprises processing one or more images obtained from an included camera having a field of view that encompasses at least a portion of the face of the user, to obtain one or more cornea-reflected images, and processing the one or more cornea-reflected images to determine whether the digit, as visible in the one or more cornea-reflected images, is in a reaching orientation with respect to the touchscreen.

46. An electronic device comprising:
a touchscreen; and
processing circuitry configured to:
detect that a user is reaching with a digit to make a touch input to the touchscreen; and
temporarily adapt a screen currently being displayed on the touchscreen, to bring an estimated touch target within a defined reach extent that is configured in the electronic device.

47. The electronic device of claim 46, wherein the processing circuitry is configured to temporarily adapt the screen by displaying a modified version of the screen until at least one of: detecting a touch input to the touchscreen, detecting expiration of an adaptation time-out period, or detecting that the digit of the user is no longer in a reaching orientation.

48. The electronic device of claim 46, wherein the processing circuitry is configured to temporarily adapt the screen by determining a layout modification for the screen to bring the touch target within the defined reach extent, and modifying a layout of the screen according to the layout modification.

49. The electronic device of claim 46, wherein the processing circuitry is configured to identify the touch target as being a screen element or screen region that is outside of the defined reach extent and in a determined reach direction.

50. The electronic device of claim 46, wherein the processing circuitry is configured to temporarily adapt the screen by at least one of: shifting the screen, rescaling the screen, and warping the screen.

51. The electronic device of claim 46, wherein the processing circuitry is configured to perform a calibration routine, wherein the processing circuitry prompts the user to make one or more touch inputs to the touchscreen and defines the defined reach extent based on the one or more touch inputs received during the calibration routine.

52. The electronic device of claim 46, wherein the processing circuitry is configured to detect that the user is reaching with the digit to make the touch input to the touchscreen by detecting that the digit is hovering over the touchscreen in conjunction with detecting that the digit is in a reaching orientation with respect to the touchscreen.

53. The electronic device of claim 46, wherein the electronic device includes a camera and wherein the processing circuitry is configured to detect that the user is reaching with the digit to make the touch input to the touchscreen by obtaining one or more images from the camera, and determining from image data obtained from the one or more images that the digit of the user is in a reaching orientation with respect to the touchscreen.

54. The electronic device of claim 53, wherein the processing circuitry is configured to determine a reach direction from the image data, and determine the touch target based at least on the reach direction.

55. The electronic device of claim 53, wherein the touchscreen does not lie within a field of view of the camera, wherein the camera is oriented to face the user in at least one handheld orientation of the electronic device, and wherein the processing circuitry is configured to determine that the user is reaching with the digit to make the touch input to the touchscreen by:
extracting one or more cornea-reflected or eyewear-reflected images from the one or more images;
processing the one or more reflected images, as said image data, to obtain orientation information for the digit with respect to the touchscreen; and
detecting that the digit is in a reaching orientation with respect to the touchscreen and detecting a corresponding reach direction, from the orientation information obtained for the digit.

56. The electronic device of claim 53, wherein the processing circuitry is configured to control the camera to be active in response to at least one of:
determining that that the screen is a certain screen or a certain type of screen for which reach detection is to be active;
determining that the screen includes one or more screen elements that are operative as touch inputs and outside of the reach extent; and
detecting a movement or orientation of the electronic device that is characteristic of reach events, said movement or orientation being determined from inertial sensor data available within the electronic device.

57. The electronic device of claim 53, wherein the one or more images comprise at least two images, and wherein the processing circuitry is configured to jointly process two or more of the at least two images to obtain one or more enhanced-resolution images and to use the enhanced-resolution images for determining whether the digit of the user is in a reaching orientation with respect to the touchscreen.

58. The electronic device of claim 46, wherein the processing circuitry is configured to detect that the user is reaching with the digit to make the touch input to the touchscreen by detecting a movement or orientation of the electronic device that is characteristic of the user extending the digit in a reaching motion with respect to the touchscreen while holding the electronic device in the hand associated with the digit, in conjunction with detecting that the digit of the user is in a reaching orientation with respect to the touchscreen.

59. The electronic device of claim 46, wherein the processing circuitry is configured to detect that the user is reaching with the digit to make the touch input to the touchscreen by processing one or more images obtained from a camera integrated within the electronic device and having a field of view that encompasses at least a portion of the face of the user, to obtain one or more cornea-reflected images, and processing the one or more cornea-reflected images to determine whether the digit, as visible in the one or more cornea-reflected images, is in a reaching orientation with respect to the touchscreen.

60. The electronic device of claim 46, wherein the electronic device comprises one of a mobile terminal, a mobile phone, a smartphone, or a User Equipment, UE.

61. An electronic device having a touchscreen, and further comprising:
a reach detection module for detecting that a user is reaching with a digit to make a touch input to the touchscreen; and
a screen adaptation module for temporarily adapting a screen currently being displayed on the touchscreen, to bring an estimated touch target within a defined reach extent that is configured in the electronic device.

62. A non-transitory computer-readable medium storing a computer program comprising program instructions that, when executed by processing circuitry of an electronic device having a touchscreen, configures the electronic device to:
detect that a user is reaching with a digit to make a touch input to the touchscreen; and
temporarily adapt a screen currently being displayed on the touchscreen, to bring an estimated touch target within a defined reach extent that is configured in the electronic device.
